(19) United States
(12) Patent Application Publication
(10) Pub. No.: US 2009/0090675 A1
(43) Pub. Date: Apr. 9, 2009

(54) Process to remove salt or bacteria by ultrasound

(76) Inventor: Ruben Garcia Marroche, Montevideo (UY)

Correspondence Address: Patent Docket Department;Armstrong Teasdale LLP, One Metropolitan Square, Suite 2600, St. Louis, MO, 63102-2740, US

(21) Appl. No.: 12/324,209

(22) Filed: Nov. 26, 2008

Related U.S. Application Data
(63) Continuation-in-part of application No. PCT/US2008/062882, filed on May 7, 2008.

(30) Foreign Application Priority Data
May 7, 2007 (UY) 30329

(51) Int. Cl. C02F 1/36

(52) U.S. Cl. 210/746; 210/739; 210/86

(57) ABSTRACT

A process for removal of salt and/or bacteria via ultrasound cavitation, which, by means of controlling cavitation, enables the salt crystals to be distilled and also aids in decanting coliforms and bacteria from the fluid by means of bursting gas bubbles within the fluid. As a result, liquids can be obtained which lead to different quality parameters with low impact on the environment, low energy costs and high production rates. The process can be applied to separate any inorganic or organic material from liquids.

### CROSS REFERENCE TO RELATED APPLICATIONS

This application is a continuation-in-part of PCT/US/2008/062882, filed May 7, 2008, having a priority date of May 7, 2007, and entitled, “A Process to Remove Salt or Bacteria by Ultrasound”, which is hereby incorporated by reference in its entirety.

### BACKGROUND OF THE INVENTION

The embodiments described herein relate generally to a process to remove salt and/or bacteria via ultrasound by controlling cavitation, which achieves the removal of salt crystals and aids in the removal of coliforms and bacteria from a fluid by means of imploding gas bubbles. As a result of this process, liquids, including water, can be obtained that meet different quality criteria, have low impact on the environment, low energy costs, and a high rate of processing. The present invention relates to the technical area of removal of salt from liquids via ultrasound and thus provides a solution to the technical problem of obtaining drinking water.

The scarcity of water has become critical. As a result, alternative methods of obtaining drinking water are being sought, including the use of underground sources. However, such sources are becoming more and more contaminated by the use of agro-chemical products. Other methods include purifying sea water, which, in order to be drinkable, must be cleansed and have the salt removed. There are numerous procedures and diverse techniques for removing salt from water, but, generally, for the most part, they can be divided into two groups. A first group involves water transforming states during the course of treatment. In such methods, water is passed through a gaseous phase involving gas compression through multiple thermal effects, including a “multiflash” thermal process. Moreover, in such a method water passes through a solid phase through freezing, wherein hydrates are formed. In the second group, water remains in its liquid state, and salt is removed through electrodialysis and inverse or reverse osmosis.

Inverse osmosis appears to be the area which has attracted the most attention from an innovation point of view, followed by technologies which use solar energy, multiflash evaporation, ionic interchange, multiple effect evaporation, steam compression and technologies that use zeolite.

In order to obtain good quality water, however, the process of inverse osmosis is time-consuming and uses a lot of energy. The process involves a single operation in which the entire transfer of the mass of water is carried out at ambient temperature, without a need for regeneration. As such, the process requires a high cost for each cubic meter of water used. During this process, the gradient of concentration existing in the space membrane-solution provokes saline ions, which are then rejected. Consequently, dielectric interactions on the surface of the membrane result in rejection of the salts so that a flow of water passes through the pores with a rejection of the salt of up to 99%. Organic substances are separated by means of a mechanical filter, in which case the degrees of filtration depend almost exclusively on the size of the particles. More specifically, the type of polymeric structure and the size of the pores allow the membranes in the inverse osmosis process to eliminate bacteria, viruses, and colloids which are present in the water. The water is then exposed to ultraviolet light, which reassures its purity. Untreated water is pre-treated via a filter and solid particles are retained by using filters of 5 microns. Water passing through the filters is re-pumped and channeled through the modules of inverse osmosis. Salt is removed from the water and two kinds of water result: one that is pure and one that contains effluents of particles.

To prolong the lifetime of the membranes, known systems use a simple washing process. To avoid multiplication of the micro-organisms retained in the membranes, periodical cleaning is performed to remove bacteria using the same system previously mentioned.

Several patents have issued that are directed to removing salt from water and the use of ultrasound cavitation to purify water and other liquids or fluids.¹ Generally, the referenced prior art describes that when an apparatus that uses ultrasound cavitation generates cavitation, a fluid is produced wherein gas bubbles implode. The process, however, is governed by random behavior, such that each new cavitation process is highly unpredictable and is only predictable on a macroscopic or general level. The referenced prior art does not disclose or suggest a possibility that the implosion of gas bubbles during cavitation can be controlled, or that a simultaneous implosion can occur in order to increase an amount of energy transmitted to the fluid, thus increasing a potential to destroy bacteria or to decant salt. Moreover, nothing in the prior art is disclosed or suggested regarding maintaining or conserving gas bubbles over a sustained period of time (sustained cavitation) so that the process of separation of the bacteria or salt from the water is carried out in a more efficient manner that includes the purification of water. ¹ See WO/1997/37937 (ultrasound design for sterilizing liquids); DE 19652127 (ultrasound equipment to remove gases dissolved in water); GB 2350106 (destruction of pathological agents by ultrasound); WO/2005/005322 (designs and processes for use in treatments using ultrasound); U.S. Pat. No. 4,434,669 (ultrasonic Doppler velocimeter for measuring blood flow); and U.S. Pat. No. 6,736,979 (device for treating liquid medium with an ultrasound emitter).

Thus, known processes of purifying water via ultrasound cavitation are completely random. When the implosion of the gas bubbles occurs randomly, such implosions may not generate a sufficient concentration of gas bubbles. As a result, any crystals dissolved in the remaining water may not reach the necessary level of concentration required to generate conditions that result in oversaturation and/or saline decantation or precipitation. This result occurs because each random implosion acts as a point of re-agitation and as a recombination within the very body of liquid being treated. When this happens, the desired level of decanted saline molecules cannot be reached.

As such, there remains a need, then, for an ultrasound process that uses a controlled cavitation that populates a fluid with a maximum density of bubbles, provides for conservation of the gas bubbles, and that maintains the gasified mass for the appropriate amount of time necessary for minerals to be decanted from fluids, or, for bacteria to be removed from fluids via simultaneous implosions that produce sufficient energy to break the external walls of the bacteria (whether aerobic or anaerobic).

### BRIEF DESCRIPTION OF THE INVENTION

In one aspect, a process to substantially eliminate contaminating matter from a liquid is provided. The process includes generating a modulated oscillation signal using at least one oscillator and a frequency modulator, transmitting the modulated oscillation signal to one energy amplifier of a plurality of energy amplifiers depending on a frequency of the modulated oscillation signal to generate an amplified signal, transmitted the amplified signal to one transducer of a plurality of transducers depending on a frequency of the amplified signal, generating cavitation bubbles of a predetermined size within the liquid based on a signal from the transducer, and imploding the cavitation bubbles to substantially eliminate the contaminating matter from the liquid.

In another aspect, an ultrasound cavitation system is provided. The ultrasound cavitation system includes a signal generating circuit configured to generate a modulated oscillation signal using at least one oscillator, and a plurality of energy amplifiers that are each configured to generate an amplified signal. Each energy amplifier is configured to receive the modulated oscillation signal depending on a frequency of the modulated oscillation signal. The system also includes a plurality of transducers configured to generate cavitation bubbles of a predetermined size within a liquid, wherein each of the transducers is configured to receive the amplified signal depending on a frequency of the amplified signal. The plurality of transducers is further configured to implode the cavitation bubbles to substantially eliminate contaminating matter from the liquid.

### BRIEF DESCRIPTION OF THE DRAWINGS

FIG. 1 is an exemplary graphical depiction of the diameter of resonance relative to the ultrasound frequency.

FIG. 2 is an exemplary graphical depiction of the density of potency relative to ultrasound frequency.

FIG. 3 is a block diagram of an exemplary process for use in removing salt and/or bacteria from a fluid via ultrasound cavitation.

### DETAILED DESCRIPTION OF THE INVENTION

Generally, the invention described herein includes two main steps: the decanting of sediment and coliforms and the removal of salt and bacteria. Each of the steps is described in more detail below. The first step, decanting of sediment and coliforms, is carried out in a water treatment unit wherein several processes occur: the preparation and injection of chemical products; coagulation; flocculation; sedimentation; filtration; and disinfection. The second step, removal of salt and bacteria, occurs during the flocculation and coagulation processes of step one.

In the exemplary embodiment, the decanting of coliforms is carried out using a dosage of aluminum sulphate and the movement of a liquid. During this phase of the process, the ultrasound procedure is implemented, which, through control of cavitation, enables the salt crystals in the liquid to be decanted and also assists in decanting the coliforms and bacteria from the liquid through the implosion of gas bubbles. The embodiments described herein provide a process to remove salt or bacteria via an ultrasound process is provided. The process uses a system wherein a frequency modulator modulates signals from a first oscillator and a second oscillator, a wide band amplifier amplifies the signals and transmits the signals to energy amplifiers depending upon the basis of frequency. The energy amplifiers are activated to cause cavitation in a hydrolic mass through transducers that are monitored by a sensor. The sensor transmits the signals to an amplifier which activates a third oscillator that cancels out the signal of the first oscillator while the signal from the second oscillator continues in a circuit. The signal from a third oscillator simultaneously is processed by a micro-processor programmed to change the frequency of the signal of the first oscillator and to change the signal of the second oscillator so that the energy amplifiers are further activated to produce a new cycle of cavitation in a hydrolic mass.

Ultrasound cavitation uses mechanical vibrations, which are induced into the surrounding area and are generated, either naturally or artificially, for scientific or industrial purposes. Ultrasound transmissions are not audible to the human ear. Specifically, since the human range of hearing is quite limited, covering approximately 20 Hz to 20 kHz, all vibrations over 20 kHz are considered to be ultrasonic. Ultrasonic transmissions can be found in the human and animal environment on many occasions. For example, ultrasound transmissions are not limited merely for use with the hearing of bats and dolphins, but rather, an action as simple as a rattling of keys produces a portion of noise that is outside the human range of hearing. Moreover, instances such as the loss of fluid under pressure through the pores of a tube, such instances which are almost inaudible, can, in some cases, only be detected by ultrasound detectors.

The parameters of interest in a vibration transmitted through any material are the local pressure induced to the particles of the material, the relative speed of the vibrations, and the movement of the particles with respect to the position the particles occupy when there are no vibrations induced.

In the frequencies used in industrial ultrasound, a length of the waves of vibration will always be several times longer than any dimensions of the molecules, such that quantum effects will not have to be taken into account. As such, in the exemplary embodiment, these means of propagation can be described as continuous. Taking these basic considerations into account, it is possible to readily establish the equations for the propagation of mechanical vibrations in gases, liquids and solids.

First, it is possible to produce mechanical vibrations in any fluid (gas or liquid) or solid, wherein the form of vibration of the particles and the speed of formation of the waves varies from case to case. Second, the speed of formation in fluids is provided by the following equation:

$${V}_{s} = \sqrt{γ ( \frac{{P}_{0}}{{p}_{0}} )} , \qquad [ Equation 1 ]$$

wherein Vₛ is the speed of formation, γ is the constant adiabatic of the matter, P₀ is the pressure to which it is submitted, and p₀ is the density at rest. It is assumed that the contractions and dilations of the fluid are adiabatic and that the real speed of the particles is sufficiently low to enter into an acoustic lineal state, that is, when Equation 1 takes the usual form of the equation of waves.

The possibilities of formation within solids are more complex because there are two types of vibration: longitudinal waves and windshear waves. With longitudinal waves, a speed of the particles has a direction of propagation, whereas in windshear waves, the movement of particles is in the same direction as the propagation of the front of the wave. In some instances, it is possible for both modes of vibration to exist simultaneously, but this is not desirable in industrial applications because the division of energy between different modes of vibration is a factor in diminishing the desired vibration.

The speed of propagation for longitudinal waves can be determined by the following formula:

$${V}_{slong} = \sqrt{( \frac{γ + 2 μ}{{p}_{0}} )} . \qquad [ Equation 2 ]$$

wherein V_{s long} is the speed of formation for longitudinal waves, γ and μ are the Lamé quotient, constant for each material, and p₀ density.

The speed of formation for transversal waves can be determined by the following formula:

$${V}_{scis} = \sqrt{( \frac{μ}{{p}_{0}} )} , \qquad [ Equation 3 ]$$

wherein V_{s cis} is the speed of formation for transversal waves, μ is the Lamé´ quotient, constant for each material, and p₀ is the density. It should be noted, however, that the coefficient μ coincides with the module of windshear for an isotrope material and that the module of Young for the material is given by the formula:

$${Y}_{0} = \frac{μ ( 3 + 2 μ )}{γ + μ} , \qquad [ Equation 4 ]$$

wherein Y₀ is the module of Young and γ and μ are the Lamé quotient, constant for each material.

The results mentioned above are valid for a means of infinite propagation. If this is not the case, then the relationships indicated above can take on different aspects. As a result, it can be shown that for a long piece of small transverse dimensions, with regard to the length of the wave, and, which is subject to a longitudinal vibration, the speed of propagation in the vibrations is given by the formula:

$${V}_{sp} = \sqrt{( \frac{{Y}_{0}}{{p}_{0}} )} , \qquad [ Equation 5 ]$$

wherein Vₛₚ is the speed of propagation, Y₀ is the module of Young, and p₀ is the density.

In the field of acoustics, a very useful concept is that of acoustic impedance with the electrical impedance of a circuit. This impedance is defined as the quotient between the pressure of the particles at a particular point and their speed, which is defined by the following formula:

$$Z = \frac{P}{V} , \qquad [ Equation 6 ]$$

wherein Z is the impedance, P is the pressure of particles at a particular point, and V is the speed of the particles. It is important to note that both P and V will be complex numbers because the problem is analyzed in a permanently sinusoidal regime. In the case of an undefined flat wave, the acoustic impedance has a real value as follows:

Z=p₀Vₛₚ, [Equation 7]

wherein Z is the impedance, p₀ is the density, and Vₛₚ is the speed of propagation in the matter. By analyzing the acoustic impedance of the different matter that an acoustic wave must travel through, one can establish the energy reflected and transmitted in each interphase. The coefficient of reflection (R) of matter 1 to another matter 2 of acoustic impedance Z₁ and Z₂, respectively, is represented by the following equation:

$$R = \frac{{Z}_{2} - {Z}_{1}}{{Z}_{1} + {Z}_{2}} , . \qquad [ Equation 8 ]$$

Normally, the resulting number will be a complex number whose module will provide the relationship of the modules with the pressure of the reflected and incidental waves, and the phase will provide the difference between both waves.

The square of the module of R provides the relationship of densities of acoustic energy, both reflected and incidental.

As discussed above, cavitation is a phenomenon of great interest in the industrial application of ultrasound. Cavitation arises in liquids and solids in a state of confusion and is defined as the formation and subsequent violent explosion of bubbles of liquid in gas form that provoke local pressure waves, which are very intense. Cavitation arises when the maximum pressure of the ultrasound wave passes through a fluid having a pressure that is greater than the difference between the hydrostatic pressure and the pressure of the steam of the fluid at the temperature at which cavitation is defined. The prior presence of bubbles favors the start of cavitation. At the same time, the existence of pointed comers on pieces immersed in the liquid makes cavitation start at those points.

There are three phases observed during cavitation: applying ultrasound; creating gas bubbles; and imploding the gas bubbles.

In the first observed cavitation phase, ultrasound is applied to a liquid wherein gas is removed from the liquid due to the low pressure of steam of the dissolved gas. The liquid transforms into a gas in the form of small gas bubbles that interact with the pressure waves from the ultrasound, wherein the bubbles group together and are enlarged. On reaching a particular diameter, resonance is produced and the gas bubbles start to vibrate, until eventually the gas bubbles burst, imploding or collapsing on themselves and producing an intense pressure wave that extends throughout the fluid. The dimensions at which the gas bubbles resonate vary according to the frequency of the ultrasound applied.

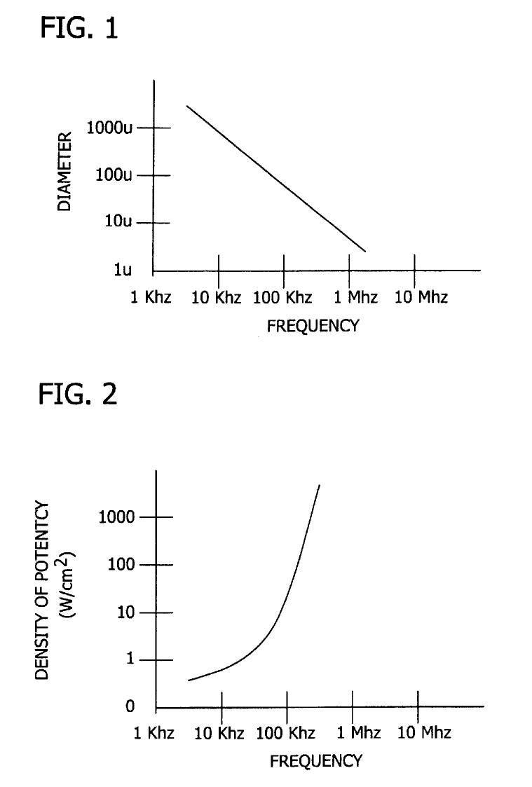

FIG. 1 is an exemplary graph of the diameter of resonance relative to the frequency of the ultrasound applied. As shown in FIG. 1, the diameter of resonance decreases as the frequency increases. From the curve, it can be seen that if the gas bubbles initially present in the liquid are of a size greater than the resonance, then cavitation will occur at either a very low intensity or not at all. Moreover, this implies that if the gas is not removed from the liquid beforehand, the maximum frequency of ultrasound to be used in order to create cavitation may be severely limited. On the other hand, however, the violence of the bursting of the gas bubbles depends upon the relationship between the maximum diameter that the bubbles achieve upon resonation and their initial diameter. Thus, if the frequency is high, the diameter will be small, and the effect of the shock wave produced will be minimal. For practical purposes, this limits the frequencies which are useful to those frequencies below 1 Mhz. As a result, the potency of the ultrasound applied must be greatly increased in order to achieve the effects of high frequencies.

FIG. 2 illustrates an exemplary relationship between the density of potency needed to produce cavitation and the frequency. As shown, as the frequency increases, the greater the density of potency is required. For this reason, in practice, and, above all, in ultrasound washing, it is uncommon to use frequencies above 100 kHz. Rather, normally 20 kHz or below are used so that cavitation is not audible, which would represent a significant nuisance for those conducting the tests.

One of the principal and substantive objectives of the current invention is to create a process to control cavitation, maintain the population of gas bubbles, and selectively and substantially eliminate contaminating matter in a liquid through the use of ultrasound cavitation.

As described above, generally the prior art discloses a randomly generated ultrasound process, wherein gas bubble implosions occur sporadically. When this happens, the random implosions do not generate a sufficient concentration of gas bubbles because some bubbles are being created, others are imploding. Moreover, while this is occurring, the crystals dissolved in the remaining liquid in the hydrolic mass do not reach the necessary level of concentration in order to generate conditions of oversaturation leading to saline decantation or precipitation. Rather, each random implosion acts as a point for re-agitation and recombination within the liquid being treated, resulting in the prevention of the desired decantation of the saline molecules.

Accordingly, a process is needed that contains the following characteristics: ordered implosion, simultaneous implosion, and sustained cavitation. Specifically, there is a need for the gas bubbles to implode in an ordered manner through an operative control of a sequence. Further, there is a need for simultaneous implosion of the gas bubbles to occur in order to obtain a greater degree of energy being transmitted to the liquid, and therefore obtaining a greater power of destruction of the bacteria and greater power of saline decantation. Moreover, there is a need to maintain and/or conserve the micro-bubbles for a prolonged period of time without imploding. The micro-bubbles must be conserved for the appropriate amount of time required to ensure that the separation in the liquid can be performed in an efficient manner, all the way up to, and including, a liquid state of purity.

Through these steps, one can control the randomness of the gas bubble implosion when using an ultrasound cavitation process. This control of cavitation facilitates the liquid being populated with a maximum of density of gas bubbles and maintains the gasified mass for the requisite time necessary for any minerals to be decanted or bacteria to be destroyed. When a simultaneous implosion occurs, sufficient energy is produced to break the external cellular membranes of the bacteria, whether the bacteria are aerobic or anaerobic. As a result, the issues presented by the prior art can be resolved by controlling the cycle of cavitation and maintaining certain conditions whereby the cycle, after commencing, is not terminated, but, rather, continues so that the liquid continues to be populated with gas bubbles during the time that is necessary to obtain the maximum quantity of bubbles possible, thus provoking the implosion of gas bubbles when the gas bubbles reach a particular, desired size.

Through the current invention, one can establish the desired size of the gas bubble by means of modulating the frequency of a transducer, so that the desired gas bubble size induces a frequency of resonance of a certain desired bacteria. The ultrasound resonance, coupled with the massive implosion of the gas bubbles, produces the rupture of the cellular membrane surrounding the bacteria and subsequently destroys all of the gas bubbles whose size is equal to, or less than, that of the gas bubble produced. This allows for the process to have a certain selectivity, which, compared to a random gas bubble implosion, leads to a greater efficiency with regards to the length of time needed to purify a liquid and also a more efficient use of energy.

The requisite conditions for cavitation control and gas bubble conservation are obtained by finding the frequencies of resonance that will keep the appropriate stationary wave traveling through the liquid in the particular recipient that contains it. In this manner, one can select the appropriate conditions and dimensions depending upon the particular recipient, and thus lead to a reliable selectivity.

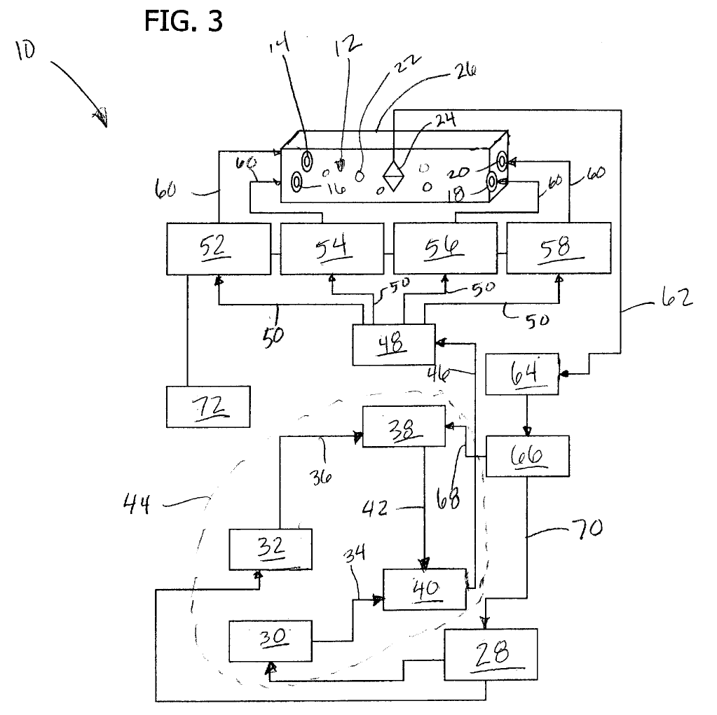

FIG. 3 illustrates a system 10 for a process to control ultrasound cavitation, maintain a population of gas bubbles, and selectively and substantially eliminate contaminating matter in a liquid 12 through the use of ultrasound cavitation. The control of frequencies of resonance is affected by transducers 14, 16, 18, and 20, which have different frequencies of resonance with a close bandwidth. In the exemplary embodiment, system 10 includes four transducers 14, 16, 18, and 20, although system 10 may include any suitable number of transducers that enable system 10 to function as described herein. When a first transducer 14, which has a different resonance than the other transducers 16, 18, and 20, generates a first gas bubble 22, the bubble 22 reaches a size which is close to that of its resonance. At that point, the first gas bubble 22 implodes. When the circuit switches to another transducer 16, 18, or 20, the frequency applied to the liquid 12 will vary and the gas bubbles generally will shrink in size and then begin to grow bigger. Once the gas bubbles approach implosion, the frequency changes again, and the cycle is repeated until the liquid 12 is saturated with salt in a manner wherein the salt decants toward the bottom of the liquid 12, and wherein no gas bubbles 22 are present. This precipitation is monitored by at least one sensor 24 within the liquid 12. After the precipitation has occurred, the gas bubble implosion is provoked at the desired size in order to obtain a secondary effect wherein the bacteria are eliminated from the liquid. As a result of the process, one can simultaneously decant crystals and destroy bacteria within a liquid with increased efficiency due to the synergies produced between them.

When removing salt by decantation, sensor 24 situated in the interior of a container 26 containing the liquid 12 monitors information regarding the conductivity of the solution until it detects a certain level of concentration, which is predetermined by a microprocessor 28. A logical order is produced wherein the transducers 14, 16, 18, and 20 do not change frequency, but rather the process of cavitation proceeds to a state of massive implosion of the gasified bubbles.

When destroying bacteria contained in the liquid 12, the process uses massive implosion of the maximum density of gas bubbles possible in certain conditions of cavitation, which are obtained as described above. By modulating the frequency of a transducer 14, 16, 18, or 20, it is possible to produce a gas bubble 22 of a predetermined size, wherein the frequency of resonance is that of the desired bacteria to be eliminated. The actions of the ultrasound and the massive implosion of the gas bubbles breaks the cellular membrane which encloses the bacteria and destroys all of the bacteria whose size are the same as, or less than, that of the gas bubble produced by the transducer 14, 16, 18, or 20.

Furthermore, the process described herein has the ability to separate any inorganic or organic material contained in a liquid, decant crystals within a liquid, create water that is drinkable, create water that is both chemically and biologically pure, and, as mentioned above, destroy bacteria within a liquid.

As shown in the exemplary embodiment of FIG. 3, a first oscillator 30 and a second oscillator 32 emit oscillation signals 34 and 36, respectively. Signal 36 from second oscillator 32 passes through a differential amplifier 38 prior to being transmitted to a frequency modulator 40. Frequency modulator 40 receives signal 34 from first oscillator 30 and an amplified signal 42 from second oscillator 32 and differential amplifier 38, and modulates the two signals 34 and 42. First oscillator 30, second oscillator 32, differential amplifier 38, and frequency modulator 40 form a signal generating circuit 44 configured to generate a modulated oscillation signal 46. After modulation, frequency modulator 40 transmits modulated oscillation signal 46 to a wide band amplifier 48, which amplifies signal 46. After wide band amplifier 48 amplifies signal 46, wide band amplifier 48 transmits an amplified signal 50 to an energy amplifier 52, 54, 56, or 58 depending on the frequency of signal 46 received by wide band amplifier 48. Thereafter, energy amplifier 52, 54, 56, or 58 is activated and transmits a signal 60 to a transducer 14, 16, 18, or 20 depending on a frequency of signal 60 received.

The transducer 14, 16, 18, or 20 causes cavitation in a hydrolic mass or liquid 12 through the use of sensor 24. More specifically, a signal 62 received by sensor 24 registers with sensor 24 and is transmitted to an amplifier 64 which, in turn, activates a third oscillator 66. Third oscillator 66 emits a signal 68 which cancels out signal 34 of first oscillator 30. However, signal 36 from second oscillator 32 continues in circuit 44. Moreover, a signal 70 emitted from third oscillator 66 is simultaneously processed by micro-processor 28 that provokes a change in the frequency of signal 34 of first oscillator 30 and a change in signal 36 of the second oscillator 32. As a result, the change provoked in the frequency of signal 34 of first oscillator 30 and signal 36 of second oscillator 32 is once again transmitted to an energy amplifier 52, 54, 56, or 58 depending upon the new frequency produced in modulated signal 46. Once this occurs, a new cycle of cavitation begins.

System 10 can also include a potency controller 72 which controls the energy sent to the energy amplifiers 52, 54, 56, and/or 58. Energy amplifiers 52, 54, 56, and 58 do not include a regulating force of their own, so that the variation in the energy sent to them is possible to modulate the width of the signal sent to the transducer 14, 16, 18, or 20.

As discussed above, the process allows for a state of cavitation to be maintained wherein a maximum density of bubbles in a gasified fluid for a particular frequency of resonance is produced, thus enabling the maximum density of bubbles to be maintained for a required period of time. Further, when a particular frequency of resonance is selected to achieve a certain cavitation of the hydrolic mass, separation of a specific component will occur wherein the specific component is suspended or dissolved in a fluid. One of the components that can be separated from the liquid, and, subsequently removed from the liquid, is coliform bacteria. As a result of the process, pure water can be obtained which can also be used as drinking water.

Exemplary embodiments of a process to remove salt or bacteria via ultrasound are described above in detail. The ultrasound process is not limited to the specific embodiments described herein, but rather, components of systems and/or steps of the method may be utilized independently and separately from other components and/or steps described herein. For example, the method may also be used in combination with other ultrasound systems and methods, and are not limited to practice with only the ultrasound systems and methods as described herein. Rather, the exemplary embodiment can be implemented and utilized in connection with many other ultrasound applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A process to substantially eliminate contaminating matter from a liquid, said process comprising:
generating a modulated oscillation signal using at least one oscillator and a frequency modulator;
transmitting the modulated oscillation signal to one energy amplifier of a plurality of energy amplifiers depending on a frequency of the modulated oscillation signal to generate an amplified signal;
transmitted the amplified signal to one transducer of a plurality of transducers depending on a frequency of the amplified signal;
generating cavitation bubbles of a predetermined size within the liquid based on a signal from the transducer; and
imploding the cavitation bubbles to substantially eliminate the contaminating matter from the liquid.

2. A process in accordance with claim 1 further comprising:
monitoring information regarding a conductivity of the liquid using a sensor within the liquid;
transmitting a signal from the sensor to an oscillator; and
transmitting a signal from the oscillator to the frequency modulator, the signal from the oscillator configured to cancel at least a portion of the modulated oscillation signal.

3. A process in accordance with claim 2 further comprising:
transmitting the signal from the sensor to a micro-processor;
transmitting at least one signal from the micro-processor, the at least one signal configured to change a frequency of the modulated oscillation signal.

4. A process in accordance with claim 1, wherein generating a modulated oscillation signal using at least one oscillator and a frequency modulator further comprises:
generating a first oscillation signal using a first oscillator;
generating a second oscillation signal using a second oscillator;
transmitting the first oscillation signal and the second oscillation signal to the frequency modulator to generate the modulated oscillation signal.

5. A process in accordance with claim 4 further comprising:
transmitting the second oscillation signal to a differential amplifier; and
transmitting an amplified oscillation signal from the differential amplifier to the frequency modulator.

6. A process in accordance with claim 1, wherein transmitting the modulated oscillation signal to one energy amplifier of a plurality of energy amplifiers depending on a frequency of the modulated oscillation signal to generate an amplified signal further comprises:
transmitting the modulated oscillation signal to a wide band amplifier; and
transmitting the modulated oscillation signal from the wide band amplifier to the energy amplifier depending on the frequency of the modulated oscillation signal.

7. A process in accordance with claim 1, wherein imploding the cavitation bubbles to substantially eliminate the contaminating matter from the liquid further comprises imploding the cavitation bubbles to separate at least one of an inorganic material and an organic material from the liquid.

8. A process in accordance with claim 1, wherein imploding the cavitation bubbles to substantially eliminate the contaminating matter from the liquid further comprises imploding the cavitation bubbles to separate salt crystals from the liquid such that the salt crystals are decanted from the liquid.

9. A process in accordance with claim 1, wherein imploding the cavitation bubbles to substantially eliminate the contaminating matter from the liquid further comprises imploding the cavitation bubbles to destroy bacteria in the liquid.

10. A process in accordance with claim 9, wherein generating cavitation bubbles of a predetermined size within the liquid based on a signal from the transducer further comprises generating the cavitation bubbles of the predetermined size, wherein the predetermined size is based on a type of the bacteria to be destroyed.

11. A process in accordance with claim 1, wherein imploding the cavitation bubbles to substantially eliminate the contaminating matter from the liquid further comprises imploding the cavitation bubbles to destroy coliform bacteria in the liquid.

12. An ultrasound cavitation system comprising:
a signal generating circuit configured to generate a modulated oscillation signal using at least one oscillator;
a plurality of energy amplifiers that are each configured to generate an amplified signal, wherein each energy amplifier of said plurality of energy amplifiers is configured to receive the modulated oscillation signal depending on a frequency of the modulated oscillation signal; and
a plurality of transducers configured to generate cavitation bubbles of a predetermined size within a liquid, wherein each of the transducers of said plurality of transducers is configured to receive the amplified signal depending on a frequency of the amplified signal, said plurality of transducers further configured to implode the cavitation bubbles to substantially eliminate contaminating matter from the liquid.

13. An ultrasound cavitation system in accordance with claim 12 further comprising:
a sensor within the liquid, said sensor configured to monitor information regarding a conductivity of the liquid; and
an oscillator configured to receive a signal from said sensor, said oscillator configured to transmit a signal said signal generating circuit, the signal from said oscillator configured to cancel at least a portion of the modulated oscillation signal.

14. An ultrasound cavitation system in accordance with claim 12 further comprising a micro-processor configured to transmitting at least one signal to said signal generating circuit, the at least one signal configured to change a frequency of the modulated oscillation signal.

15. An ultrasound cavitation system in accordance with claim 12, wherein said signal generating circuit further comprises:
a first oscillator configured to generate a first oscillation signal;
a second oscillator configured to generate a second oscillation signal;
a differential amplifier configured to receive the second oscillation signal and output an amplified oscillation signal; and
a frequency modulator configured to receive the first oscillation signal and the amplified oscillation signal to generate the modulated oscillation signal.

16. An ultrasound cavitation system in accordance with claim 12 further comprising a wide band amplifier configured to:
receive the modulated oscillation signal from said signal generating circuit; and
transmit the modulated oscillation signal to said energy amplifier.

17. An ultrasound cavitation system in accordance with claim 12, wherein said plurality of transducers is configured to generate the cavitation bubbles of a predetermined size based on a type of bacteria to be destroyed in the liquid.

18. An ultrasound cavitation system in accordance with claim 12 wherein said energy amplifier does not include a regulated source of supply such that said energy amplifier supplies energy modulated in a width of the amplified signal sent to said transducers.

19. An ultrasound cavitation system in accordance with claim 12, wherein said signal generating circuit, said plurality of energy amplifiers, and said plurality of transducers are configured to maintain a state of cavitation and a maximum density of bubbles in the liquid for a particular frequency of resonance such that the maximum density of bubbles is maintained for a required period of time.

20. An ultrasound cavitation system in accordance with claim 19, wherein the particular frequency of resonance is selected to achieve an appropriate cavitation of the liquid that is required to separate a specific component from the liquid, wherein the specific component is at least one of suspended and dissolved in the liquid.
